(19) United States
(12) Patent Application Publication
(10) Pub. No.: US 2015/0055334 A1
(43) Pub. Date: Feb. 26, 2015

(54) STREET LIGHTING FIXTURE HAVING AN INDUCTION LAMP

(71) Applicant: Tinson HUANG, Guangdong Province (CN)

(72) Inventor: Tinson HUANG, Guangdong Province (CN)

(21) Appl. No.: 13/975,836

(22) Filed: Aug. 26, 2013

(51) Int. Cl. F21V 23/02; F21V 23/00

(52) U.S. Cl. CPC F21V 23/02; F21V 23/002
USPC 362/222; 362/296.01

(57) ABSTRACT

A street lighting fixtures and more particularly to a street lighting fixture having an induction lamp having an improved form and structure regarding the currently existing fixtures wherein the street lighting fixture comprising: a housing having a first end, a second end and an inner surface divided in a light reflector retaining portion and a ballast retaining portion; a reflector, attached to the inner surface of the housing, said reflector having a light source; an insulating panel, dividing the inner surface of the housing in a light reflector retaining portion and a ballast retaining portion; and a transparent cover, covering at least a portion of the light reflector retaining portion and the ballast retaining portion.

### BACKGROUND OF THE INVENTION

A. Field of the Invention The present invention is related to street lighting fixtures and more particularly to a street lighting fixture having an induction lamp having an improved form and structure regarding the currently existing fixtures.

B. Disclosure of the Related Art

Nowadays, technological development related to public lighting is focused to increase the useful life of the fixtures maintaining a high light intensity with low energy consumption induction lamps are high technology lighting accessories following said development focus.

Induction lamps are based on the high frequency plasma discharge principle. Said lamps are a new scientific and technological achievement related with the optical, power electronics, plasma science and materials science, and have the advantage of being highly efficient, have a long useful life, a high color rendering index, being environment friendly and achieve great energy savings. They are suitable to be installed in tunnels, high traffic zones, subway stations, vestibules and other public areas.

Current induction lamps are designed to be used in fixture structures having complicated structure, having a high cost and a low universality. As the upper part of the traditional fixture is a completely flat surface or comprising a single curve surface, the inner space is limited and is not suitable for installing a large induction lamp and the ballast. The light source of a traditional fixture is installed directly at the top, causing a low convergent effect.

Furthermore current streetlight fixtures usually have a narrow space which is not suitable to install the induction light source and ballast. Therefore, it's necessary to provide a new type of streetlight fixture for installing the induction and to satisfy the increasing need of road illumination.

In view of the disadvantages formerly mentioned of the existing technology, applicant developed a fixture which has an induction lamp having an improved form and structure regarding the currently existing fixtures.

The lighting fixture of the present invention comprises: a concave aluminum housing divided in a light reflector retaining portion and an ballast retaining portion by means of an insulating panel, a removable concave light reflector housed and retained inside the light reflector retaining portion, a high transmittance glass cover covering the light reflector retaining portion and the ballast retaining portion and a waterproof and dustproof gasket surrounding the glass cover, said light reflector having a light source chamber and said ballast retaining portion having an upper ballast joining plate.

Some of the advantages of the lighting fixture of the present invention are the following: it has sufficient space for the installation of the induction lamp and a ballast; the aluminum casing reduces the weight of the lighting fixture; the high transmittance glass cover, improves light transmittance, and allows an easy transmission of heat from the light source chamber to the exterior; the dustproof gasket makes the light fixture can dust and water resistant, extending the life of the induction lamp; the insulating board, dividing the aluminum casing in a light reflector retaining portion and an ballast retaining portion prevents the heat of the light source to reach the ballast retaining portion, thus preventing the overheating of the ballasts, and extending the life of its electronic parts and devices; and the ballast mounting plate allows the installation to of a variety of ballasts.

### SUMMARY OF THE INVENTION

It is therefore a main object of the present invention, to provide a street lighting fixture having an induction lamp comprising: a concave aluminum housing divided in a light reflector retaining portion and an ballast retaining portion by means of an insulating panel, a removable concave light reflector housed and retained inside the light reflector retaining portion, a high transmittance glass cover covering the light reflector retaining portion and the ballast retaining portion and a waterproof and dustproof gasket surrounding the glass cover, said light reflector having a light source chamber and said ballast retaining portion having an upper ballast joining plate.

It is still a main object of the present invention to provide a street lighting fixture which has sufficient space for the installation of the induction lamp and a ballast

It is another object of the present invention to provide a street lighting fixture having an induction lamp of the above disclosed nature, in which the aluminum casing reduces the weight of the lighting fixture.

It is still another object of the present invention, to provide a street lighting fixture having an induction lamp of the above disclosed nature, in which the high transmittance glass cover, improves light transmittance, and allows an easy transmission of heat from the light source chamber to the exterior.

It is still a main object of the present invention, to provide a street lighting fixture having an induction lamp of the above disclosed nature, in which the dustproof gasket makes the light fixture can dust and water resistant, extending the life of the induction lamp.

It is another object of the present invention, to provide a street lighting fixture having an induction lamp of the above disclosed nature, in which the insulating board, dividing the aluminum casing in a light reflector retaining portion and an ballast retaining portion prevents the heat of the light source to reach the ballast retaining portion, thus preventing the overheating of the ballasts, and extending the life of its electronic parts and devices.

It is still another object of the present invention, to provide a street lighting fixture having an induction lamp of the above disclosed nature, in which and the ballast mounting plate allows the installation to of a variety of ballasts.

These and other objects and advantages of the present invention will became apparent to those skilled in the art, from the following detailed description of the invention.

### BRIEF DESCRIPTION OF THE DRAWINGS

FIG. 1 is a perspective disassembled view of the street lighting fixture of the present invention.

FIG. 2 is a lower view of the concave aluminum housing of the street lighting fixture of the present invention.

FIG. 3 is an upper view of the concave aluminum housing of the street lighting fixture of the present invention.

FIG. 4 is a lower view of the concave reflector of the street lighting fixture of the present invention.

### DETAILED DESCRIPTION OF THE INVENTION

The lighting fixture of the present invention will now described referring to a preferred embodiment thereof and in combination with the accompanied drawings, wherein the same signs refer to the same drawn elements.

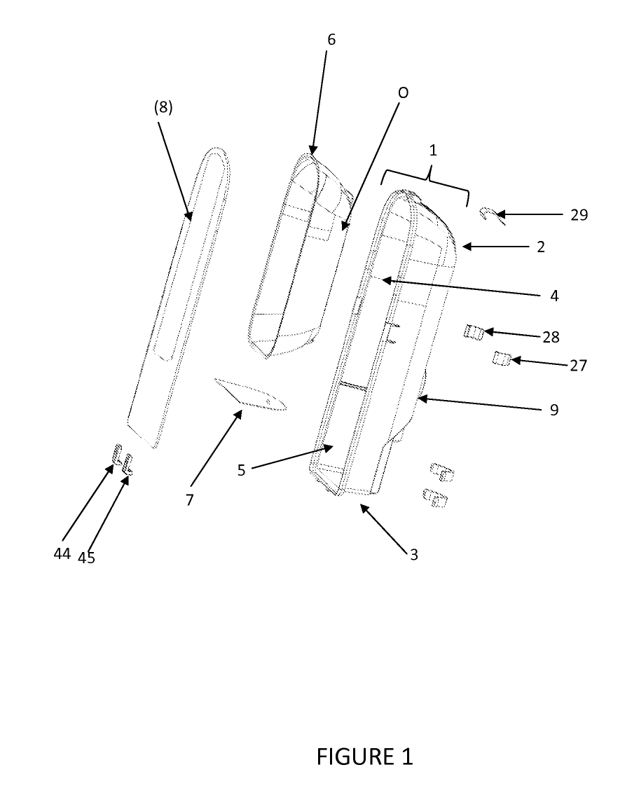

Referring to FIG. 1, the lighting fixture of the present invention comprises in its most general embodiment:

an elongated concave aluminum housing (1) having a first end (2), a second end (3) and a concave inner surface divided in a light reflector retaining portion (4) and an ballast retaining portion (5);

a concave removable reflector (6), lodged in the concave inner surface of the housing 1, said concave reflector (6) receiving a light source;

an insulating panel (7), dividing the concave inner surface in a light reflector retaining portion (4) and an ballast retaining portion (5); and

a high transmittance glass cover (8), covering the light reflector retaining portion (4) and the ballast retaining portion (5), said high transmittance glass cover (8) joined to the periphery of the concave aluminum housing (1).

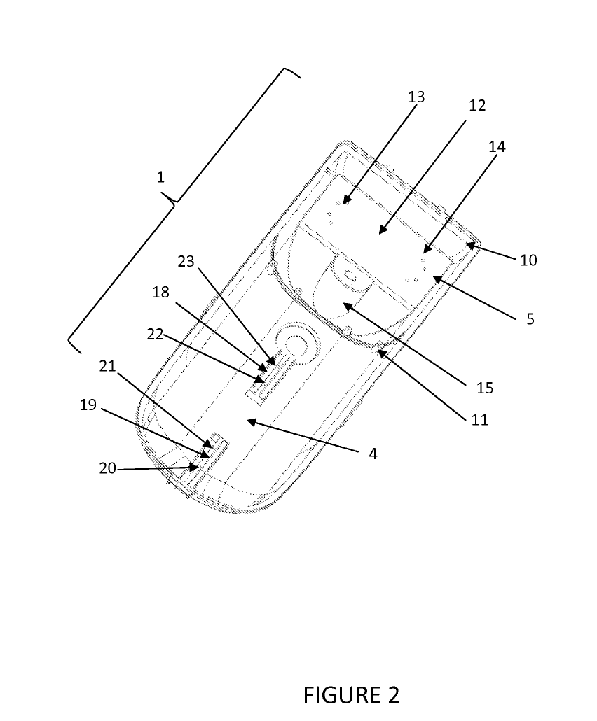

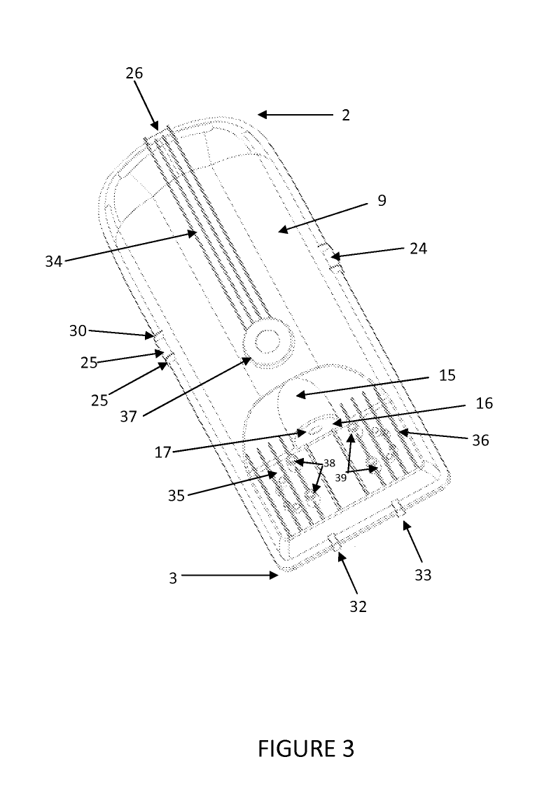

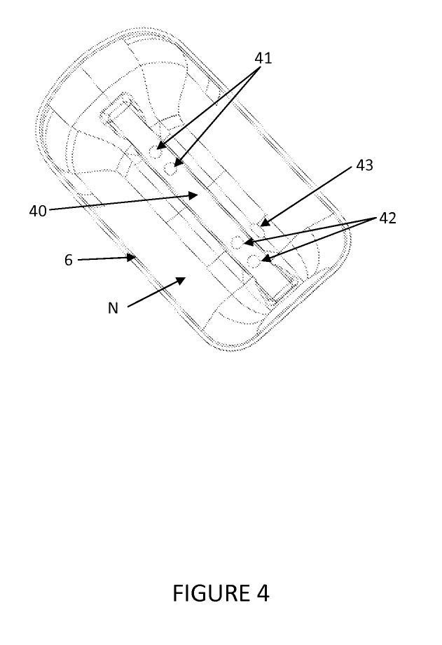

Now, referring to FIGS. 1 to 4, the street lighting fixture having an induction lamp of the present invention comprises in a specific embodiment:

a concave aluminum housing (1) (FIGS. 1, 2 and 3) comprising an elongated concave shaped member having:

a first end (2), a second end (3);

an outer surface (9);

a concave inner surface divided in a light reflector retaining portion (4) having a first longitudinal end (9) and a second longitudinal end (10), and an ballast retaining portion (5);

a transversal slot (11) located in the concave inner surface, proximate to a longitudinal middle portion of the concave aluminum housing, for receiving and retaining an edge of the insulating panel (7);

a ballast mounting surface (12), located at the ballast retaining portion of the concave aluminum housing, said ballast mounting surface having a first group (13) and a second group (14) of threaded holes, each group, opposite to each other proximate to a longitudinal side of the ballast mounting surface (12), and each group having four threaded holes for receiving the retaining screws of several sizes of ballasts;

a domed housing (15), located at the ballast retaining portion (5), at a central longitudinal portion, proximate to the transversal slot (11) and completely protruding over the outer surface (9), said domed housing having a vertical wall (16) facing the second end (3) of the concave aluminum housing (1) having a central threaded hole (17) for allowing the passage of power cables coming from a post support to the concave inner surface and to a ballast;

a first centering guide (18) and a second centering guide (19), each longitudinally located at a central portion of the light reflector retaining portion (4), wherein the first centering guide (18) is located at the first longitudinal end (9) of the light reflector retaining portion (4) and the second centering guide (19) is located proximate to the second longitudinal end (10) of the light reflector retaining portion (5) and wherein each centering guide having a pair of opposed threaded holes (20),(21),(22),(23) wherein the first centering guide (18) and second centering guide receiving and attaching the top of a concave removable reflector (6) by means of screws passing trough respective holes in the concave removable reflector and screwed inside the pair of threaded holes (20),(21),(22),(23);

a first glass cover coupler position limiter (24), a second glass cover coupler position limiter (25) and a third glass cover coupler position limiter (26) for indicating and maintaining the position of a glass cover coupler (27), (28), (29), wherein said first glass cover coupler position limiter (24) and said second glass cover coupler position limiter (25), each depending from the periphery of the concave aluminum housing (1) proximate to a middle longitudinal portion thereof, opposite to each other, wherein the third glass cover coupler position limiter (26)

is located at a first end of the concave aluminum housing (1), depending from the periphery of the concave aluminum housing proximate to a middle transversal portion thereof, and wherein each glass coupler position limiter (24), (25), (26) comprising a pair of flat opposed parallel members (30), (31) depending from the periphery of the concave aluminum housing;

a first hinge support (32) and a second hinge support (33) each joined at the second end (3) of the concave aluminum housing (1) at equal distances from a middle transversal portion of said second end (3) for receiving a respective hinge and pivotally join an end of a glass cover (8) covering the light reflector retaining portion (4);

a first group of four bearing strips (34), a second group of four bearing strips (35) and a third group of four bearing strips (36), wherein the first group of four bearing strips (34) are formed in the outer surface of the concave aluminum housing (1), longitudinally located at a central transversal portion thereof and extending from the first end (2) to approximately a middle longitudinal portion of the concave aluminum housing (1), and wherein the second group of four bearing strips (35) and a third group of third bearing strips (36) are each formed in the outer surface of the concave aluminum housing (1) and respectively located at the second end (3) thereof, each group located at equal distances from a middle transversal portion of said second end (3) and extending from said second (3) to approximately the whole length of the ballast retaining portion (5) said first group of four bearing strips (34), and said second group of four bearing strips (35) each bearing against an horizontal portion of a street light post (not shown) when the concave aluminum housing (1) is attached thereof, thus avoiding direct contact between the street light post and the outer surface (9) of the concave aluminum housing (1);

a cylindrical housing (37) for containing light control circuitry, proximate to a central longitudinal portion of the concave aluminum housing (1) and at a central transversal portion thereof, completely protruding from its outer surface (9);

a first pair of raised screw receptacles (38) and a second pair of raised screw receptacles (39), each pair located proximate to the second end (3) of the concave aluminum housing (1), and in opposite lateral sides of the concave aluminum housing (1) and protruding over the outer surface (9) said first pair of raised screw receptacles (38) and said second pair of raised screw receptacles (39) receiving a respective first and a second pair of screws (not shown) for attaching the concave aluminum housing (1) to a light street post by means of a first clamp and a second clamp;

a concave removable reflector (6), lodged in the concave inner surface of the concave aluminum housing (1), said concave removable reflector (6) receiving a light source, said concave removable reflector (6) having:

a concave inner surface (“N”) and an outer surface (“0”) (FIG. 1), wherein the top of the outer surface (39) is flat;

an elongated light source hollow support member (40) longitudinally joined to a central portion of the inner surface (38), said elongated light source hollow support member (40) having two pair of holes (41), (42) to receive joining screws of the light source, such as an induction light;

a perforation (43) located in a superior portion of the concave removable reflector for allowing the pass of power cables to the concave inner surface and to the light source;

a high transmittance glass cover (8), covering the light reflector retaining portion (4) and the ballast retaining portion (5), said high transmittance glass cover (8) removable joined to the periphery of the concave aluminum housing (1) by means of three glass cover couplers (not shown) each lodged between the flat opposed parallel members of a correspondent cover coupled position limiter (25) and pivotally joined by means of a first hinge (44) and a second hinge (45) (FIG. 1) to a correspondent hinge support (32), (33).

Finally, it should be understood that the street lighting fixture having an induction lamp of the present invention, is not limited exclusively to the embodiments above disclosed and illustrated and that the persons ordinary skilled in the art could, with the teachings herein disclosed of the invention, make modifications to the street lighting fixture having an induction lamp of the present invention, which will be clearly within the inventive concept and scope of the invention which is claimed in the following claims.

1. A street lighting fixture having an induction lamp comprising:
a housing having a first end, a second end and an inner surface divided in a light reflector retaining portion and an ballast retaining portion;
a reflector, attached to the inner surface of the housing, said reflector having a light source;
an insulating panel, dividing the inner surface of the housing in a light reflector retaining portion and an ballast retaining portion; and
a transparent cover, covering at least a portion of the light reflector retaining portion and the ballast retaining portion.

2. A street lighting fixture as claimed in claim 1, wherein the housing comprising a concave aluminum housing having:
a first end, a second end;
an outer surface;
a concave inner surface divided in a light reflector retaining portion having a first longitudinal end and a second longitudinal end, and a ballast retaining portion;
means for retaining the insulating panel between the light reflector retaining portion and the ballast retaining portion;
a ballast mounting surface, located at the ballast retaining portion of the concave aluminum housing, said ballast mounting surface reiciving and retaining a ballast selected from a group comprising several sizes of ballasts;
a perforation for allowing the passage of power cables coming from a post support to the concave inner surface and to a ballast;
means for attaching a concave removable reflector at a central portion of the light reflector retaining portion;
means for pivotally joining an end of a transparent cover for covering the light reflector retaining portion; and
means for containing light control circuitry;

3. A street lighting fixture as claimed in claim 2, wherein the means for retaining the insulating panel between the light reflector retaining portion and the ballast retaining portion comprising a transversal slot located in the concave inner surface, proximate to a longitudinal middle portion of the concave aluminum housing, for receiving an edge of the insulating panel.

4. A street lighting fixture as claimed in claim 2, wherein the concave aluminum housing further including a domed housing, located at the ballast retaining portion, at a central longitudinal portion, proximate to the transversal slot and completely protruding over the outer surface, said domed housing having a vertical wall facing the second end of the concave aluminum housing having a central threaded holehaving a central threaded hole for allowing the passage of power cables coming from a post support to the concave inner surface and to a ballast.

5. A street lighting fixture as claimed in claim 2, wherein the concave aluminum housing further including a first centering guide and a second centering guide, each longitudinally located at a central portion of the light reflector retaining portion, wherein the first centering guide is located at the first longitudinal end of the light reflector retaining portion and the second centering guide is located proximate to the second longitudinal end of the light reflector retaining portion and wherein each centering guide having at least one threaded hole, wherein the first centering guide and second centering guide receiving and attaching the top of a concave removable reflector by means of screws passing trough respective holes in the concave removable reflector and screwed inside the at least one threaded hole.

6. A street lighting fixture as claimed in claim 2, wherein the concave aluminum housing further including a first transparent cover coupler position limiter, a second transparent cover coupler position limiter and a third transparent cover coupler position limiter for indicating and maintaining the position of a transparent cover coupler, wherein said first transparent cover coupler position limiter and said second transparent cover coupler position limiter, each depending from the periphery of the concave aluminum housing proximate to a middle longitudinal portion thereof, opposite to each other, wherein the third transparent cover coupler position limiter is located at a first end of the concave aluminum housing depending from the periphery of the concave aluminum housing proximate to a middle transversal portion thereof, and wherein each transparent coupler position limiter comprising a pair of flat opposed parallel members depending from the periphery of the concave aluminum housing.

7. A street lighting fixture as claimed in claim 2, wherein the concave aluminum housing further including a first hinge support and a second hinge support each joined at the second end of the concave aluminum housing at equal distances from a middle transversal portion of said second end for receiving a respective hinge and pivotally join an end of a transparent cover for covering the light reflector retaining portion.

8. A street lighting fixture as claimed in claim 2, wherein the concave aluminum housing further including at least one group of bearing strips, formed in the outer surface of the concave aluminum housing, for bearing against an horizontal portion of a street light post when the concave aluminum housing is attached thereof, thus avoiding direct contact between the street light post and the outer surface of the concave aluminum housing.

9. A street lighting fixture as claimed in claim 2, wherein the concave aluminum housing further including a first group of bearing strips, a second group of bearing strips and a third group of bearing strips, wherein the first group of bearing strips are formed in the outer surface of the concave aluminum housing, longitudinally located at a central transversal portion thereof and extending from the first end to approximately a middle longitudinal portion of the concave aluminum housing, and wherein the second group of bearing strips and a third group of bearing strips are each formed in the outer surface of the concave aluminum housing and respectively located at the second end thereof, each group located at equal distances from a middle transversal portion of said second end and extending from said second to approximately the whole length of the ballast retaining portion said first group of bearing strips, and said second group of bearing strips each bearing against an horizontal portion of a street light post when the concave aluminum housing is attached thereof, thus avoiding direct contact between the street light post and the outer surface of the concave aluminum housing;

10. A street lighting fixture as claimed in claim 2, wherein the concave aluminum housing further including a cylindrical housing for containing light control circuitry, proximate to a central longitudinal portion of the concave aluminum housing and at a central transversal portion thereof, completely protruding from its outer surface.

11. A street lighting fixture as claimed in claim 2, wherein the concave aluminum housing further including a first pair of raised screw receptacles and a second pair of raised screw receptacles, each pair located proximate to the second end of the concave aluminum housing, and in opposite lateral sides of the concave aluminum housing and protruding over the outer surface said first pair of raised screw receptacles and said second pair of raised screw receptacles receiving a respective first and a second pair of screws for attaching the concave aluminum housing to a light street post by means of a first clamp and a second clamp.

12. A street lighting fixture as claimed in claim 1 wherein the reflector comprising a concave removable reflector, retained inside the inner surface of the housing, said concave removable reflector receiving a light source, said concave removable reflector having:
a concave inner surface and an outer surface, wherein the top of the outer surface is flat;
an elongated light source hollow support member longitudinally joined to a central portion of the inner surface, said elongated light source hollow support member having two pair of holes, for receiving joining screws of a light source, such as an induction light;
a perforation located in a superior portion of the concave removable reflector for allowing the pass of power cables to the concave inner surface and to the light source.

13. A street lighting fixture as claimed in claim 2 wherein the reflector comprising a concave removable reflector, retained inside the concave inner surface of the concave aluminum housing, said concave removable reflector receiving a light source, said concave removable reflector having:
a concave inner surface and an outer surface, wherein the top of the outer surface is flat;
an elongated light source hollow support member longitudinally joined to a central portion of the inner surface, said elongated light source hollow support member having two pair of holes, for receiving joining screws of a light source, such as an induction light;
a perforation located in a superior portion of the concave removable reflector for allowing the pass of power cables to the concave inner surface and to the light source;

14. A street lighting fixture as claimed in claim 2 wherein the transparent cover comprising a high transmittance glass cover.

15. A street lighting fixture as claimed in claim 9 wherein the trasparent cover comprising a high transmittance glass cover, covering the light reflector retaining portion and the ballast retaining portion, said high transmittance glass cover removably joined to the periphery of the concave aluminum housing by means of three glass cover couplers each lodged between the flat opposed parallel members of a correspondent cover coupled position limiter and pivotally joined by means of a first hinge and a second hinge to a correspondent hinge support.
